(19) United States
(12) Patent Application Publication
(10) Pub. No.: US 2021/0034014 A1
(43) Pub. Date: Feb. 4, 2021

(54) SUBMERGED MECHANICAL TIMEPIECE

(71) Applicant: Montre Liquide AG, Pfäffikon (CH)

(72) Inventor: Morten Beyer, Roedkaersbro (DK)

(21) Appl. No.: 16/968,053

(22) PCT Filed: Jan. 16, 2019
(86) PCT No.: PCT/EP2019/051047

§ 371 Date: Aug. 6, 2020

(30) Foreign Application Priority Data
Feb. 9, 2018 (DE) 10 2018 001 049.0
Sep. 13, 2018 (DE) 10 2018 007 229.1

(51) Int. Cl. G04B 1/26; G04B 37/02

(52) U.S. Cl. CPC G04B 1/26; G04B 37/02

(57) ABSTRACT

The invention relates to a timepiece with an escapement based on resistance to the flow of a fluid, comprising a pump arranged for continuously and uninterruptedly pumping said fluid.

### FIELD OF THE INVENTION

The invention concerns timepieces, especially mechanical timepieces that do not rely on an electrical motor for driving the timepiece gears. More specifically, the invention concerns mechanical watches.

### BACKGROUND OF THE INVENTION

A watch is a timepiece intended to be carried or worn by a person. It is designed to keep working despite the motions caused by the person's activities. A wristwatch is designed to be worn around the wrist, attached by some kind of strap or bracelet.

During most of its history the watch was a mechanical device, driven by clockwork, powered by winding a mainspring, and keeping time with an oscillating balance wheel. While today, most watches are inexpensive and medium-priced, used mainly for timekeeping, and have quartz movements, more expensive collectible watches often have traditional mechanical movements. Compared to electronic movements, mechanical watches are often less accurate and they are sensitive to position, temperature and magnetism. They are also costly to produce, require regular maintenance and adjustments, and are more prone to failures. Nevertheless, the craftsmanship of mechanical watches still attracts interest from part of the watch-buying public, especially among the watch collectors.

Traditional mechanical watch movements use a spiral spring, often called a mainspring, as a power source. In manual watches, the spring must be rewound periodically by the user by turning the watch crown. Alternatively, the spring may be automatically rewound using the natural motion of the wearer (self-winding watch). The invention concerns both these types of mechanical watches.

A conventional mechanical movement uses an escapement mechanism to control and limit the unwinding of the mainspring, converting what would otherwise be a simple unwinding into a controlled and periodic energy release. A conventional mechanical movement uses an escapement comprising a balance wheel together with a balance spring (also known as a hairspring) to control motion of the gear system of the watch. Such a conventional escapement transfers energy to the timekeeping element (the “impulse action”) and allows the number of its oscillations to be counted (the “locking action”). The impulse action transfers energy to the balance wheel to replace the energy lost to friction and other similar factors during its cycle and keep the timekeeper oscillating. The escapement is driven by force from the mainspring, transmitted through the timepiece's gear train. Each swing of the balance wheel releases a tooth of the escapement's escape wheel gear, allowing the clock's gear train to advance or “escape” by a fixed amount. This regular periodic advancement moves the clock's hands forward at a steady rate. At the same time the tooth gives the timekeeping element a push, before another tooth catches on the escapement's pallet, returning the escapement to its “locked” state. The sudden stopping of the escapement's tooth is what generates the characteristic “ticking” sound heard in operating mechanical clocks and watches.

### GENERAL DESCRIPTION OF THE INVENTION

Such known mechanical movements suffer from a number of drawbacks. The escapements use fairly fragile balance springs, which may break or wear out, and are very sensitive to mechanical shock. Such springs can also only be used if the interior of the timepiece is filled with a gas, such as air, in a controlled pressure range. This severely limits the range of external pressures under which the timepiece can operate, and requires the timepiece to have high-performance seals if the timepiece must be able to perform under water, especially at elevated pressures, such as at relevant depths when diving. Generally, such clockworks can not operate if the clockwork is “submerged”, i. e. the interior of the timepiece is filled with a liquid, such as an oil, because the viscosity of the liquid would effectively prevent the function of the balance wheel.

In order to overcome these and other shortcomings of prior art timepieces, the instant invention is specifically concerned with mechanical movement timepieces that do not use a balance wheel/balance spring type escapement. Instead, the invention uses an escapement based on resistance to the flow of a fluid, especially a liquid.

Liquid-driven escapements are known in the art. They are generally based on deriving equal incremental portions of liquid from a (continuous or discontinuous) flow of liquid, generally water, and counting the portions. The assumption is that the flow of liquid will be even and will not change with time, so that the number of portions will be in direct proportion with the passing of time. While the invention is based on a fundamentally different concept, this prior art will now be described in some more detail:

The earliest liquid-driven escapement was apparently described by the Greek engineer Philo of Byzantium (3rd century BC) in his technical treatise Pneumatics (chapter 31). A counterweighted spoon, supplied by a water tank, tips over in a basin when full, releasing a spherical piece of pumice in the process. Once the spoon has emptied, it is pulled up again by the counterweight, closing the door on the pumice by the tightening string. Philo's comment that “its construction is similar to that of clocks” indicates that such escapement mechanisms were already integrated in ancient water clocks.

In China, the Tang dynasty Buddhist monk Yi Xing made an escapement in 723 (or 725) to the workings of a water-powered armillary sphere and clock drive, cf. Needham, Joseph (1986). Science and Civilization in China: Volume 4, Physics and Physical Technology, Part 2, Mechanical Engineering. Taipei: Caves Books Ltd, p. 319. Further information on Chinese water-based escapements can be found in the Wikipedia article on escapements, from which the above information derives. For example, water flowed into a container on a pivot. The escapement's role was to tip the container over each time it filled up, thus advancing the clock's wheels each time an equal quantity of water was measured out. The time between releases depended on the rate of flow, which decreased with water pressure as the level of water in the source container dropped.

The development of mechanical clocks depended on the invention of an escapement which would allow a clock's movement to be controlled by an oscillating weight. Unlike the continuous flow of water in the Chinese device, the medieval escapement was characterized by a regular, repeating sequence of discrete actions and the capability of self-reversing action:

Both techniques used escapements, but these have only the name in common. The Chinese one worked intermittently; the European, in discrete but continuous beats. Both systems used gravity as the prime mover, but the action was very different. In the mechanical clock, the falling weight exerted a continuous and even force on the train, which the escapement alternately held back and released at a rhythm constrained by the controller. Ingeniously, the very force that turned the escapement wheel then slowed it and pushed it part of the way back . . . . In other words, a unidirectional force produced a self-reversing action—about one step back for three steps forward. In the Chinese timekeeper, however, the force exerted varied, the weight in each successive bucket building until sufficient to tip the release and lift the stop that held the wheel in place. This allowed the wheel to turn some ten degrees and bring the next bucket under the stream of water while the stop fell back.

It is evident that the above-described prior art devices were big and limited to macroscopic handling of water, literally in buckets, with a continuous flow of water available to supply the mechanism, and with an outlet or a reservoir available for the discarded water. Such technologies are of very limited accuracy and of course, could not be used in a mobile timepiece, especially in a user-wearable timepiece, such as a watch.

U.S. Pat. No. 3,540,208 discloses a watch with an oil-filled chamber housing a piston. The piston has a through-boring and is moved by a mainspring through the chamber, which causes the oil to flow through the boring. The speed of this flow determines the time it takes for the pistons to move through the chamber. When the piston has reached the end of its travel path, it must be moved back into its starting position, and this interrupts the time measuring process. Thus this watch is not capable of continuous uninterrupted time measurement.

It is an important object of this invention, to disclose a timepiece that avoids the shortcomings of known mechanical timepieces, which rely on a balance wheel/balance spring escapement.

It is a further important object of the invention to disclose a timepiece which uses the flow of a fluid, especially a liquid, to measure the passing of time, and can be embodied as a wearable item.

It is an another important object of the invention to disclose a timepiece, especially a user-wearable timepiece such as a watch, that can have a submerged movement such that the interior of the timepiece is filled with liquid.

It is a further important object of the invention to disclose a timepiece, especially a user-wearable timepiece such as a watch, that permits continuous, uninterrupted measurement of time.

These and other objects of the invention are attained by the invention as defined in the attached independent claims.

The attached subclaims define preferred embodiments of the invention.

### DETAILED DESCRIPTION OF THE INVENTION

In contrast to the above-described Chinese prior art mechanisms, the invention departs from the idea of generating discrete, incremental portions of liquid, the number of which indicates the passing of time. Instead, the invention uses a precisely controlled flow of a fluid, which is preferably a liquid under the operating conditions of the timepiece, to control and regulate the unwinding of the timepiece's power source, which is preferably a mainspring. Of course, the power source need not be a spring. In preferred embodiments, the mainspring drives a pump which causes the flow of the liquid through a flow control device, such as a settable valve. This flow meets a certain flow resistance depending on the setting of the flow control device.

The flow of the liquid corresponds to the performance of the pump, so that limiting the flow by setting the flow control device correspondingly limits the performance of the pump: When the flow through the flow control device is reduced, the operation of the pump is correspondingly reduced, since the flow control device acts to brake the pump. Setting the flow control device to a specific flow rate of the liquid thus effectively controls the unwinding of the mainspring, since the mainspring is mechanically linked to the pump. If the flow is even and constant with time, it can be used to measure and display the passing of time, by monitoring the unwinding of the mainspring, e. g. by monitoring the action of the pump. The pump is preferably a continuous flow pump, i. e. it can maintain a continuous flow of the liquid, and therefore a continuous uninterrupted measurement of time, also during the necessary winding or setting steps.

Thus, the invention can basically be defined as a timepiece with an escapement based on resistance to the flow of a fluid. Note that in this operation, it is not necessary to monitor or measure the amount of liquid passing the valve, as in the above-mentioned Chinese prior art. The flow rate of the liquid is irrelevant. The only relevant action is setting the flow control device to a flow rate at which the unwinding of the mainspring drives the clockwork at the right speed to correctly indicate the time.

As in all typical contemporary mechanical timepieces, preferred embodiments of the inventive timepiece comprise a windable spring (i. e. a mainspring) as its main or sole power supply. Where necessary, two or more mainsprings can be used in a stacked arrangement., to increase the power reserve of the timepiece. The timepiece may have a fairly conventional crown arrangement for winding the spring, for setting the time display etc.

The timepiece comprises a fluid, the flow resistance of which is used in the escapement. Preferably, the fluid is a liquid over the complete set of conditions to which the timepiece may be exposed. Such conditions preferably include conditions of above 10 KPa pressure and above 220 K., and up to 500 MPa and up to 400 K.

Suitable liquids comprise basically all liquids which meet the above conditions and are sufficiently stable over extended time periods, without exhibiting relevant chemical and/or physical change to their properties. Specifically, suitable liquids will show no chemical decomposition or other reaction, under the conditions prevailing in the timepiece, over years or even decades, even when exposed to light. Presently the most preferred such liquids are silicone oils, especially silicone oils with no reactive functional groups. A silicone oil is any liquid polymerized siloxane with organic side chains. Since in the invention, reactivity should be as reduced as possible, the siloxanes forming the liquid will have inert side chains showing as little reactivity as possible.

One example of a preferred silicone oil is PSF-20cSt Pure Silicone Fluid, a polydimethylsiloxane oil available from Clearco Products.

The timepiece of the invention uses the flow resistance of the fluid, preferably liquid, in its escapement. In preferred embodiments, in order to create the required flow, the timepiece internally comprises a pump arranged for pumping the liquid. The pump is driven by the windable mainspring, usually through a set of gearwheels to create the optimum power supply for the pump. The pump is preferably a mechanical pump and most preferably a gear pump. Alternatively, the pump can be a piston pump, a membrane pump, a bellows pump or any other suitable type of pump, that is capable of continuous operation, said operation being uninterrupted as long as the driving force provided by the mainspring is sufficient to drive the pump.

In order to have a suitable, well defined, constant flow resistance in the pumped liquid, the timepiece preferably comprises a, preferably adjustable, flow control device arranged to limit the flow of the fluid therethrough. The liquid is pumped through the flow control device by the pump, which is driven by the unwinding of the mainspring. The flow control device limits the flow of the liquid and thereby acts as a brake on the pump. The running speed of the pump is determined by the flow of the liquid through the flow control device., irrespective of the power reserve stored in the mainspring. If necessary, the pump can be connected to the flow control device via a pressure reduction device, which makes sure that the input pressure of the flow control device is suitable and constant. Thus, the flow control device determines the speed with which the mainspring unwinds and keeps this speed constant. This permits to set the speed of the timepiece, by setting the flow rate of the liquid, and permits to derive the time measuring and displaying functions from basically every element (e. g. a gearwheel) in the power train from the mainspring to the flow control device. E. g., since the running speed of the pump depends on the flow rate of the fluid through the flow control device, the running speed of the pump can be directly used to measure and indicate the passing of time.

If desired, the time measuring and displaying functions can be realized in that the fluid exiting the flow control device is conducted to a drive unit driven by the fluid and the running speed of the drive unit is used to indicate the passing of time. The drive unit can e. g. comprise a rotor, which is driven by the output flow from the flow control device.

The constant, unchanging performance of the flow control device is critical since the flow resistance of the fluid (especially, liquid) when passing through the flow control device is the basis for the escapement action and must be as reliably constant as the action of a balance wheel in a conventional mechanical timepiece. On the other hand, the flow will generally require some initial setting when the timepiece is started for the first time, and may even need some later adjustment. The flow must be extremely uniform also under changing ambient conditions to which the timepiece may be exposed. It has been found that in one very suitable embodiment of the invention, the flow control device is a valve, preferably a valve arranged for adjustable throughput of fluid, and most preferred a needle valve with adjustable aperture. Given suitable overall construction of the timepiece, the valve, especially needle valve, can be arranged such that it can be set or adjusted from the outside without having to open the timepiece. It is e. g. contemplated to have an inbuilt connector that extends to the exterior of the timepiece and permits such adjustment, comparable to the known crown device which permits setting of the time hands, and winding the mainspring.

The flow control device will have a temperature compensation feature, to ensure that the flow rate of the liquid through the flow control device is independent of the liquid's temperature. The temperature compensation can be based on selecting at least one material with a thermal expansion performance that compensates for changes in the liquid's temperature. This can be achieved by selecting a homogenous material, e. g. a polymeric material, or a non-homogenous material, e. g. a bimetallic material, with said characteristics. If e. g. the flow control device is a needle valve, the needle can be made from a suitable polymeric material and arranged in a holder, to automatically compensate for the temperature fluctuations to which a timepiece is usually exposed (say, between 5° C. and 65° C.). Such arrangements are basically known e. g. from hydraulic suspension controls and can easily be adapted for use in the invention.

In all presently preferred embodiments of the invention, the timepiece is internally substantially, preferably completely, filled with the fluid, which is preferably a liquid. In other words, the invention uses preferably a ,,submerged“ movement with all its mechanical parts completely immersed in the liquid that also serves to provide the escapement function. This has several advantages, e. g. in that no sophisticated seals are needed, even when the timepiece is intended to be exposed to very high external liquid pressures, such as in deep diving operations, since there is no relevant difference in compressibility between the liquid, such as silicone oil, in the timepiece, and the external liquid such as seawater. When the timepiece is entirely filled with liquid, the pump supplying liquid to the flow control device may simply take the liquid in from the liquid fill in the timepiece, and the flow control device may release the flow of liquid back into the interior of the time piece in basically any desired fashion. Except for the connection between the pump outlet and the flow control device inlet, there is no need for any special pressure-resistant or pressure-proof conduits.

When the timepiece is completely filled with liquid, thermal expansion of the liquid may pose a problem beyond affecting the flow control device. The timepiece must be able to accommodate increasing or decreasing liquid volumes without bursting or sucking external fluid in. The invention may in preferred embodiments therefore have a compensation device arranged to compensate for increasing or decreasing liquid pressure in the timepiece, preferably comprising a membrane or bellows arranged to expose its outer surface to the interior of the timepiece, while its interior surface is exposed to the ambient exterior of the timepiece. In this arrangement, the bellows will be compressed when the liquid in the timepiece expands, and will expand when the liquid contracts. Of course, the compensation device can be arranged to expand and compress in the opposite direction.

Other than the above indicated elements and parts which are specific to the invention, the inventive timepiece can correspond to a conventional mechanical watch. It can specifically have gearing, hands, a watch face etc. like any customary watch. The invention could thus be put into operation basically by replacing the escapement mechanism of a conventional mechanical watch with the escapement of the invention, and filling the watch with the invention's liquid.

### EMBODIMENT EXAMPLE

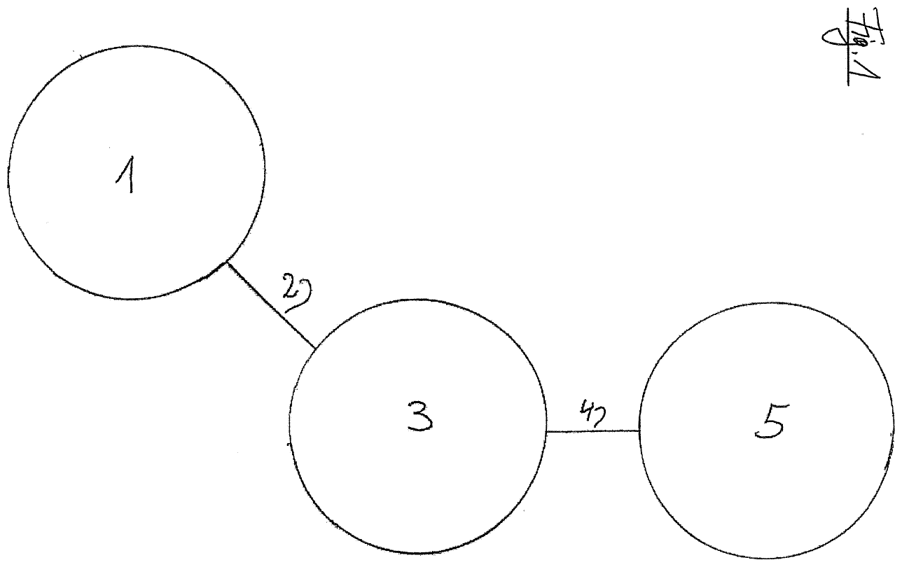

A first preferred embodiment of the invention will now be described with reference to the attached FIG. 1, which schematically shows some core elements of the invention and their interaction.

In the first preferred embodiment, which comprises a housing (not shown) enclosing the complete timepiece movement, the housing is filled with a liquid, such as a dimethicone oil. The movement is thus submerged in the liquid.

In this embodiment, the timepiece is powered by a mainspring 1, which drives the timepiece's movement when it unwinds.

The mainspring 1 drives a pump 3 through suitably arranged gearing 2. The pump 3 is a hydraulic pump such as a gear pump.

When driven by the mainspring 1 through the gearing 2, the pump 3 sucks in liquid from the amount of liquid filling the housing. The pump 3 pumps the liquid into a duct 4, which connects the pump's outlet to a valve 5. The valve 5 is adjustable such that its throughput can be set, and comprises a temperature compensation feature, which renders the valve's throughput temperature independent.

In operation, the throughput of the valve 5 controls the speed of the pump 3, since the pump 3 cannot run faster than the passage of liquid through the valve 5 permits. Since the pump 3 is mechanically connected to the mainspring 1 by gearing 2, the speed of pump 3 controls the unwinding of the mainspring 1.

The timepiece will have hands or some other device for indicating time on a dial or clockface (not shown). These can be moved by connecting them, in a fashion known per se, to the movement, e. g. at the gearing 2 or the pump 3. The escapement shown in the Figure can replace the mechanical escapement in a known timepiece, connected thereto via suitable gearing.

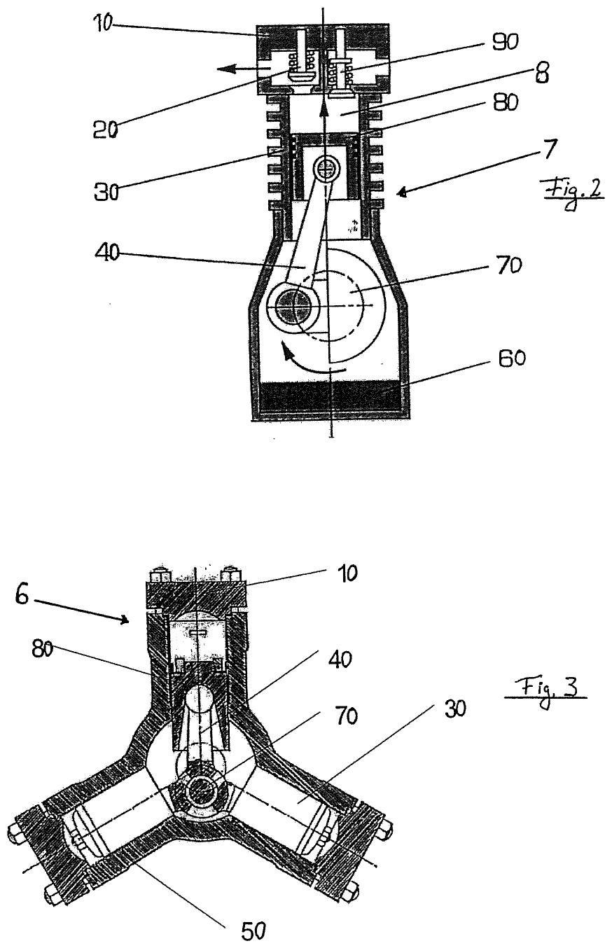

In another preferred embodiment, shown partly in FIGS. 2 and 3, the timepiece is constructed basically as in the first embodiment. The gearpump of the first embodiment is however replaced by a continuous flow piston pump. In the second embodiment, the piston pump (6) comprises three expansion and compression chambers (8) which in this embodiment are formed by cylinders (30) housing pistons (80) reciprocatingly movable therein, said cylinders being arranged in a star-shaped configuration, as is schematically shown in FIG. 3

In other embodiments, the number of expansion and compression chambers can be different. Preferably, there are at least two such chambers, to avoid dead center problems. Again, in other embodiments, the pump may comprise membrane or bellows pump elements instead of the cylinder-and piston elements of the second embodiment. The arrangement may be other than star-shaped.

As shown in FIGS. 2 and 3, the pistons (80) are commonly driven by a crankshaft (70) at the center of the pump (6), said crankshaft being driven by the mainspring of the watch through suitable gearing. The pistons (80) are connected to the crankshaft (70) by piston rods (40).

FIG. 2 shows a single cylinder unit (7) of the type used in the second embodiment, but not combined with two other cylinders as in FIG. 3.

The cylinder unit (7) has a cylinder head (10) which closes the cylinder (30) at the top end thereof. The cylinder covers houses an intake valve (90) and an exhaust valve (20) which serve to control the continuous flow of liquid in the expansion and compression chamber (8). Both valves (90,20) are spring-loaded so that they are normally closed (NC valves).

The piston (80) is driven to reciprocate in the cylinder (30) by crankshaft (70) via piston rod (40). When the piston (80) moves towards the crankshaft (70), the intake valve (90) opens and lets liquid flow from the housing into chamber (8). When the piston (80) reaches its position closest to the crankshaft (70), the intake valve (90) closes. As the piston (80) begins to move away from the crankshaft (70), exhaust valve (20) opens and lets liquid flow out of chamber (8).

In the arrangement of FIG. 3, the cylinder units do not have the bottom part and oil sump (60) shown in FIG. 2. Instead, they share a crankcase (50) which has the crankshaft (70) at its center, so that all cylinder units can be commonly driven by said crankshaft (70).

Exhaust valve (20) lets the liquid flow into a duct (not shown) which connects all cylinder units to a valve, like valve (5) in the first embodiment. This valve thus receives all liquid exiting the cylinder units, and its setting controlls the back-pressure building up at every exhaust valve (20). This back-pressure acts to controll the working speed of the cylinder units, similar to the function of the gearpump in the first embodiment. The ducts connecting all cylinder unit outlets to the common adjustable valve, cf. FIG. 1, valve (5), can e. g. be made of metal tubing, which has the mechanical strenght to bear the liquid pressure.

1. A timepiece with an escapement based on resistance to the flow of a fluid, comprising a pump arranged for continuously and uninterruptedly pumping said fluid.

2. The timepiece of claim 1, comprising at least one windable spring as its main or sole power supply.

3. The timepiece of claim 1 or 2, internally comprising a fluid, especially a fluid that is a liquid under conditions of above 10 KPa pressure and above 220 K.

4. The timepiece of claim 3, wherein the fluid is a liquid under conditions of up to 500 MPa and up to 400 K.

5. The timepiece of claim 1, wherein the fluid comprises an inert liquid, especially comprising at least one silicone oil, preferably a non-reactive, inert silicone oil.

6. The timepiece of claim 1, said pump being a mechanical pump and preferably being a gear pump, a piston pump, a membrane pump or a bellows pump.

7. The timepiece of claim 6, wherein the pump is driven by the windable spring.

8. The timepiece of claim 1, comprising a, preferably adjustable, flow control device arranged to limit the flow of the fluid therethrough.

9. The timepiece of claim 8, wherein the flow control device is a valve, preferably a valve arranged for adjustable throughput of fluid, and most preferred a needle valve with adjustable aperture.

10. The timepiece of claim 8, provided with a temperature compensation feature, to ensure that the flow rate of the liquid through the flow control device is independent of the liquid's temperature, said temperature compensation being preferably based on selecting at least one material with a thermal expansion performance that compensates for changes in the liquid's temperature, and especially based on selecting a homogenous material, e. g. a polymeric material, or a non-homogenous material, e. g. a bimetallic material, with said characteristics.

11. The timepiece of claim 8, wherein the fluid is pumped through the flow control device and the flow rate of the fluid is used to measure and indicate the passing of time.

12. The timepiece of claim 11, wherein the running speed of the pump depends on the flow rate of the fluid through the flow control device and the running speed is used to measure and indicate the passing of time.

13. The timepiece of claim 11, wherein the fluid exiting the flow control device is conducted to a drive unit driven by the fluid and the running speed of the drive unit is used to measure and indicate the passing of time.

14. The timepiece of claim 1, wherein the timepiece movement is enclosed by a housing and a compensation device is arranged to compensate for thermal expansion and contraction of the housing, said compensation device preferably comprising a membrane or bellows arranged to expose its outer surface to the interior of the housing, while its interior surface is connected to the ambient exterior of the housing.

15. The timepiece of claim 1, provided with a housing enclosing the movement, wherein the housing is internally completely filled with the fluid, especially the liquid.

16. The timepiece of claim 1, provided with a winding device for winding one or more springs providing power to the timepiece, and preferably provided with a setting device for the flow rate of the fluid.

17. A mechanical timepiece, preferably a timepiece in accordance with claim 1, provided with a housing enclosing the timepiece work or movement, wherein the interior of the timepiece is substantially and preferably completely, filled with a fluid that is a liquid at ambient pressure and temperature, especially at 100 KPa and 273 K.

18. The timepiece of claim 17, wherein the escapement is based on the flow resistance of the liquid.

19. The timepiece of claim 18, wherein an adjustable flow control device is arranged to set the flow rate of the liquid.

20. The timepiece of claim 1, said timepiece being a watch, especially a wristwatch.
